(19) United States
(12) Patent Application Publication
(10) Pub. No.: US 2004/0123721 A1
(43) Pub. Date: Jul. 1, 2004

(54) Manual valve cover plate for diatonic harmonica

(75) Inventor: William R. Vogtman III, Cumberland, MD (US)

Correspondence Address: William R. Vogtman III, 707 Hill Top Drive, Cumberland, MD, 21502, US

(73) Assignee: William R. Vogtman III, Cumberland, MD

(21) Appl. No.: 10/330,793

(22) Filed: Dec. 27, 2002

(51) Int. Cl. G10D 7/12

(52) U.S. Cl. 84/377

(57) ABSTRACT

The Manual Valve Cover Plate for Diatonic harmonica allows for hands-free, foot-free engagement or disengagement of a valve at the player's discretion. Design, enhancement, and operation of the valve are disclosed. The purposes of the valve are to uncomplicate and to make available the processes of standard bending, over bending, and valved bending on one standard diatonic harmonica. Furthermore, such a device will not truncate any traditional diatonic harmonica playing.

### CROSS-REFERENCE TO RELATED APPLICATIONS

| | | | |
|---|---|---|---|
| 2,339,790 | January 1944 | Magnus | 84/377 |
| 3,674,910 | April 1972 | McKenzie | 84/377 |
| 5,367,937 | November 1994 | Epping | 84/377 |
| 5,739,446 | April 1998 | Bahnson | 84/377 |
| US2002/0000154 A1 | January 2002 | Antaki | 84/377 |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Since the original invention of the ten-holed diatonic harmonica, the status of the instrument has grown from one of a mere toy, to that of a familiar folk and popular instrument. However, many people still view the ten-holed diatonic harmonica as being limited to the modal play of such folk and popular musical forms. In response to such a challenge, many advanced and virtuoso players are currently extending the bounds of the ten-holed diatonic harmonica with new and innovative techniques. Such innovative techniques allow the advanced player to play a full chromatic scale through the range of the selected diatonic harmonica. Two camps of innovators have developed full chromatic ability—one camp favoring a valved-bending technique (subsequently referred to as valved bending), the other favoring an overblow-overdraw technique (subsequently referred to as over bending). Each technique also allows for different expression and musical subtlety.

Bending a note in general can be defined as the continuous or discontinuous changing of the frequency at which one or more reeds vibrate by changing the resonance chamber created by the player's oral cavity. As noted by Bahnson (U.S. Pat. No. 5,739,446) in column 1, lines 22 through 26, standard bending technique is accessible to moderately advanced players. Furthermore, standard bending can be performed on a diatonic harmonica without modification to the instrument. A standard draw bend occurs when a player changes the shape of his or her oral cavity so that the draw reed resonates at a lower pitch than normal. At the same time, the corresponding blow reed begins sympathetic vibration. As this process continues, the blow reed eventually facilitates most if not all of the vibration of the lower pitch. This occurs in holes in which the draw reed is higher in pitch than the blow reed. A standard blow bend occurs in the opposite manner (paraphrase from Epping Description U.S. Pat. No. 5,367,937, pages 3 to 5 of 16 online).

Over bending a note occurs in a manner similar to the standard bending described in [0002]. An over blow occurs when a player changes the shape of his or her oral cavity in a manner similar to a bend. However, instead of altering the pitch of the blow reed to a lower frequency, the draw reed resonates at a higher frequency. As this process continues, the draw reed eventually facilitates most if not all of the vibration of the higher pitch. This occurs in holes in which the blow reed is higher in pitch than the draw reed. An over draw occurs in the opposite manner (paraphrase from Bahnson, column 2, lines 50 through 63).

Valved bending was probably first pioneered by chromatic harmonica players, although the author has found no source that verifies the origin of valved bending. “Flap valves have frequently been employed on chromatic harmonicas as a wind or breath saving device” (McKenzie U.S. Pat. No. 3,674,910, column 1, lines 57 through 58). Such flap valves, when working perfectly, channel all of a player's expelled or inhaled air over a single reed. The player's oral cavity may then be changed to decrease the pitch of the single vibrating reed. Many harmonica companies have placed similar valves over selected reeds in diatonic harmonicas to facilitate valved bending in diatonic harmonicas.

Many technical problems exist with standard diatonic harmonicas when all but the most advanced players attempt standard bends, over bends, and/or valved bends. The most common of these problems is unwanted air leakage. Such leakage is referred to by many: Antaki, US2002/0000154 A1, [0015], [0023]; Magnus, U.S. Pat. No. 2,339,790, column 1, lines 55 through 58; and McKenzie U.S. Pat. No. 3,674,910, column 1, lines 57 through 58 for example. In over bending specifically, such leakage produces “discordant whistling or squeaking” when one attempts to play a note (Antaki, US2002/0000154 A1, [0015]). It can also cause unwanted polyphonic reed vibration similar to a desired result produced in modern jazz saxophone solos. A problem specific to the flap valves is a buzzing vibration of the flap valve in sympathy with reed vibration producing unwanted noise (McKenzie U.S. Pat. No. 3,674,910, column 1, lines 58 through 63).

Specifically for over bends, Bahnson U.S. Pat. No. 5,739,446 solved the leakage problem by incorporating a set of sliding louver valves operated by a hand into a fully integrated diatonic harmonica. However, Antaki US2002/0000154 A1 states in [0021], “The Bahnson harmonica . . . require[s] the player to activate the valve at the exact instant that the [over bend] note is to be played, thus requiring additional motions and interactions with the harmonica by the player, and preventing modulation of frequency” and amplitude as required for certain effects. Additionally, the manner in which the louver valves are engaged does not allow for fluid valved bending for the intermediate player. Nor may a player depress the louver slide while playing a harmonica in a hands-free rack often used by guitar players.

A single device that can solve the majority of the leakage problems, allow for over bending, valved bending, and standard bending, eliminate flap valve buzzing, and improve overall tone could unify the two camps of advanced players. It could also make advanced techniques accessible to intermediate level players. Furthermore, such techniques could be preformed without truncating a player's hand techniques. It would also expand the techniques for hands-free play in a rack. Also, it would allow a player access to the expressive techniques of standard bending, over bending, and valved bending on the same harmonica. As a convenience, such a device can be embodied such that the device may be attached to any existing diatonic harmonica. Finally, a device with few moving parts and of simple, durable design could be fashioned in an inexpensive manner.

### BRIEF SUMMARY OF THE INVENTION

In response to the problems summarized in [0007] above, the Manual Valve Cover Plate for Diatonic Harmonica has been invented. The invention is an enhanced version of the existing cover plates on diatonic harmonicas. The new cover plate could be sold as a package set with an existing set of reed plates and comb, or as a stand-alone product that allows the player to upgrade his or her own harmonica.

The new cover plate includes a lip-operated valve that may be engaged or disengaged at the will of the player and independent of oral cavity air pressure. When the pressure of the lip against a flexible membrane in the cover plate is negligible, the manual valve remains in the open position. In the open position, the harmonica to which the plate is attached operates in a manner almost identical to an unaltered harmonica. When the pressure of the lip against a flexible membrane in the cover plate is significantly increased, the manual valve is displaced into the closed position. In the closed position, the manual valve prevents airflow around a set of reeds.

By choosing not to close a manual valve, a player may play the harmonica by using standard techniques. By choosing to close a valve, the player may perform:

1. An over bend without air leakage around the secondary reed,

2. An over bend without discordant whistling or squeaking from the secondary reed,

3. A valved bend,

4. A standard draw (blow) bend without air leakage around the draw (blow) reed once a bent pitch has been established,

5. A standard blow or draw without air leakage around the secondary reed,

6. An alteration of tone produced by intentionally varying the amount of air leakage, or

7. Almost any subtle expression associated with standard bending, over bending, or valved bending on the same harmonica.

### BRIEF DESCRIPTION OF THE SEVERAL VIEWS OF THE DRAWING

FIG. 1 shows a top isometric view of the assembled Manual Valve Cover Plate for Diatonic Harmonica in its preferred embodiment.

FIG. 2 shows a bottom isometric view of the assembled Manual Valve Cover Plate for Diatonic Harmonica in its preferred embodiment.

FIG. 3 shows a cross section of the assembled Manual Valve Cover Plate for Diatonic Harmonica in its preferred embodiment with valve in open position.

FIG. 4 shows a cross section of the assembled Manual Valve Cover Plate for Diatonic Harmonica in its preferred embodiment with valve in closed position.

FIG. 5 shows a cross section of the assembled Manual Valve Cover Plate for Diatonic Harmonica in its preferred embodiment with valve in open position. Reed housing is shown specifically by index 6.

FIG. 6 shows a cross section of the assembled Manual Valve Cover Plate for Diatonic Harmonica in its preferred embodiment with valve in closed position. Reed housing is shown specifically by index 6.

FIG. 7 shows top view of manual valve without cover. Spring arms are embodied as separate entities attached to main valve body.

FIG. 8 shows top view of manual valve without cover. Spring arms and main valve body are one piece.

FIG. 9 shows one possible outline of sealing material to be attached to the main body of manual valve.

FIG. 10 shows a second embodiment of sealing material to be attached to the main body of the manual valve.

FIG. 11 shows a one-piece embodiment of a net from which to create the entire Manual Valve Cover Plate by folding and welding, gluing, attaching, or fusing.

FIG. 12 shows an alternative one-piece embodiment of a net from which to create the entire Manual Valve Cover Plate by folding and welding, gluing, attaching, or fusing.

FIG. 13 shows same cross-section as FIG. 3. Possible hinge, spring, and elastic enhancements are shown.

FIG. 14 shows same cross-section as FIG. 3. Possible locking mechanism and compressible spring and/or stopper assemblies are shown. One alternative pressure bar embodiment is also shown. A possible screw for adjusting maximum open valve height is shown.

FIG. 15 shows location of other possible embodiments of pressure bar.

FIG. 16 shows cross section of and possible enhancements to a folded version of the net shown in FIG. 12. The figure also shows possible embodiment of pressure bar in which bar may roll or slide along surface of manual valve structure. A possible screw for adjusting maximum open valve height is shown

### DETAILED DESCRIPTION OF THE INVENTION

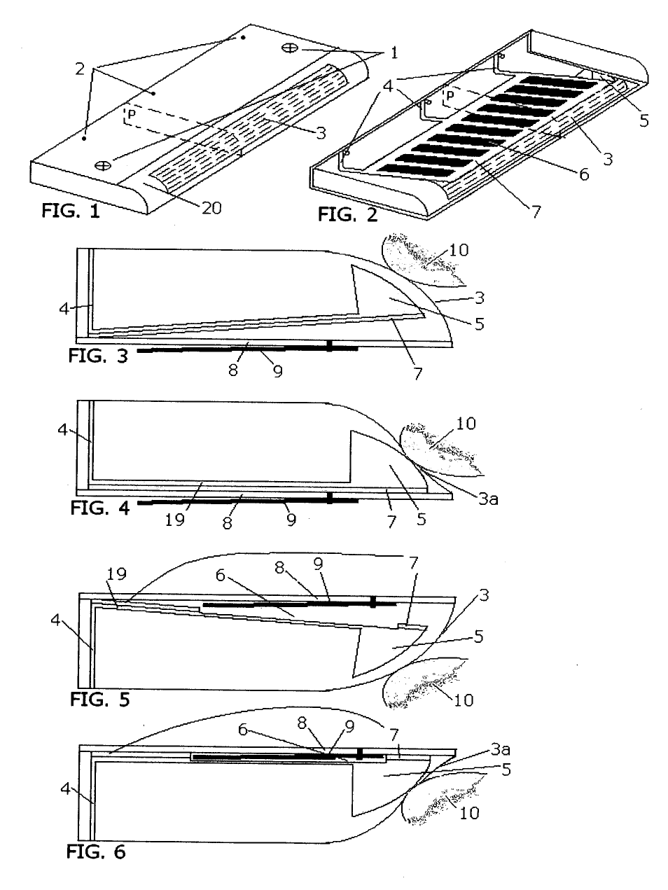

The Manual Valve Cover Plate for Diatonic harmonica is an improved version of existing cover plate design. FIGS. 3 and 4 (cross sections of FIG. 1 at plane P) best illustrate the mechanical operation of the invention.

In FIG. 3, the Manual Valve Cover Plate is shown installed on a standard reed plate (index 8) and reed (index 9). In the resting position shown in FIG. 3, the lip (index 10) applies no excess pressure. The standard diatonic harmonica functions in a manner consistent with the norm.

In FIG. 4, the lip (index 10) applies excess pressure to the elastic membrane (index 3a). The excess lip pressure deforms the elastic membrane (index 3a). The deformation of the elastic membrane transfers the force from the excess lip pressure to the pressure bar (index 5). The force on the pressure bar from the lip loads the spring arm (index 4). When the spring arm is sufficiently loaded, the padded surface of the manual valve (index 7) is placed in firm contact with the standard reed plate (index 8). With proper adjustment, the padded surface of the manual valve makes the airtight seal between itself (index 7) and the reed plate (index 8) as referred to in [0007]. Furthermore, the airtight seal facilitates the techniques described in [0010].

FIGS. 5 and 6 show mechanical rest and displacement similar to FIGS. 3 and 4. However, FIGS. 5 and 6 show a space created in the padded surface of the manual valve (index 7). The space in the padded surface allows for the creation of the airtight seal without touching the reed (index 9). Preventing the manual valve from contacting the reed preserves the fine adjustments that may have been made to the reed by the player.

Index 3 of FIG. 1 shows the position of the elastic membrane. The membrane may be constructed of plastic(s), rubber(s), elastomer(s), or any combination thereof. Ribs or a lattice of ribs made of elastic or inelastic materials may reinforce the membrane.

Proper function of the membrane requires the existence of a window in the material that comprises the main body of the cover plate. FIG. 11 best illustrates such a window (index 3b). By folding the net of material in FIG. 11 along the dashed lines, the space figure in FIG. 1 and FIG. 2 is created. Adhesive, rivets, screws, or nuts and bolts may fix the elastic membrane to the main body of the cover plate. Index 20 shows a preferred method.

Index 20 of FIG. 1 shows a strip of material added to the face of the cover plate. The elastic membrane must have dimensions larger than that of the window. By cutting, molding, or otherwise forming the membrane larger than the window, a sandwich construction may result. The main body with window serves as the bottom layer. The membrane material serves as the middle layer. The material of index 20 serves as the top layer. The top and bottom layers are, in turn, both fixed to the membrane and each other. Adhesive, rivets, screws, or nuts and bolts may fix the elastic membrane to the main body of the cover plate and the material of index 20.

Altering an existing cover plate can provide the opportunity for the window and sandwich construction of [0032].

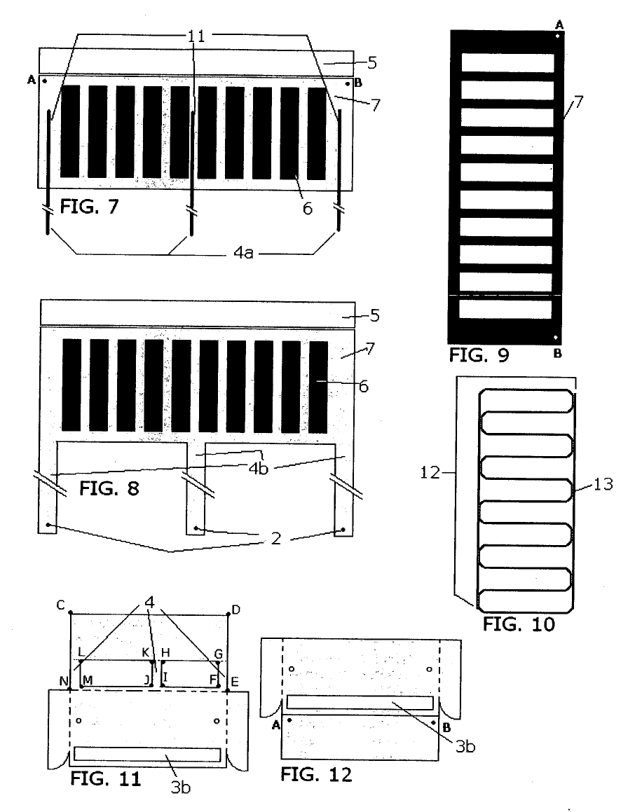

FIG. 2 introduces the valve structure of the manual valve. Index 4 shows the unloaded spring arms of the manual valve. In one embodiment, the spring arm, valve, and cover plate are made from one piece of material as shown in FIG. 11. In the embodiment of FIG. 2, the manual valve and spring arms are on piece as shown in FIG. 8. The assembly shown in FIG. 8 is attached by adhesive, rivets, screws, or nuts and bolts at index 2 to the main body of the cover plate in FIG. 2 after the spring arms are bent and fixed into position. The body material used in FIG. 8 may be a memory-prone metal, plastic, hard rubber, or combination thereof. A third embodiment is shown in FIG. 7. Index 4a shows spring steel wire attached to the main body of the valve by adhesive, rivets, screws, welding, soldering, or nuts and bolts. The spring steel spring arms would then be bent and fixed, possibly annealed then re-fixed, and attached at index 2 of FIG. 2. The spring steel spring arms can be threaded to aid attachment to the main body of the cover plate in addition to or instead of adhesive, rivets, screws, welding, soldering, or nuts and bolts.

FIG. 2 also introduces the pressure bar (index 5). The pressure bar transfers force from the lip to the manual valve body, thus loading the spring arms. FIGS. 3 through 6 show the preferred cross section of the pressure bar. FIGS. 7 and 8 show a top view of the attached pressure bar. FIG. 14 shows the pressure bar as an extension of the main body of the manual valve (index 5a). Such an extension or hole in the pressure bar may facilitate a locking mechanism (indices 21a and 21b). Index 5b in FIG. 15 shows alternate forms of the pressure bar whose embodiments can take on a closed curve with or without vertices, with or without a uniform cross section. FIG. 16, index 5c, shows a free-floating pressure bar as an additional embodiment.

FIG. 2 further reveals the padded surface of the manual valve (index 7). In the preferred embodiment, all Manual Valve Cover Plates are of uniform construction. Thus, separate manufacture processes are not needed for top and bottom cover plates. FIG. 9 shows a general form for the padded surface. The FIG. 9 form can be manufactured in uniform or non-uniform thickness. Material used for the FIG. 9 form is soft and pliable and may be constructed of cork, rubber, plastic, felt, neoprene, fabric, elastomer, or any combination thereof. Other elastic or non-elastic material may reinforce the FIG. 9 form. Points A and B in FIGS. 9 and 7 show points of alignment for the FIG. 9 form onto the manual valve body.

FIG. 10 shows a secondary embodiment of the padded surface of the manual valve. The sole purpose of the padded surface is to facilitate the desired airtight seal between the manual valve body and the reed plate (shown in FIG. 4, indices 7 and 8). An elastic sealing strip shown in FIG. 10 may produce the same airtight seal. Indices 12 show the endpoints of one continuous strip of uniform cross section. Contact points insure that each reed is sealed individually (index 13).

Another possible embodiment of the padded surface is workable. For reeds of the top reed plate, one solid rectangle of padding material may be applied to the manual valve. With adjustment for existing screws and rivets, an airtight seal may be achieved without contacting the reeds. However, such a solution unnecessarily extends the manufacture process.

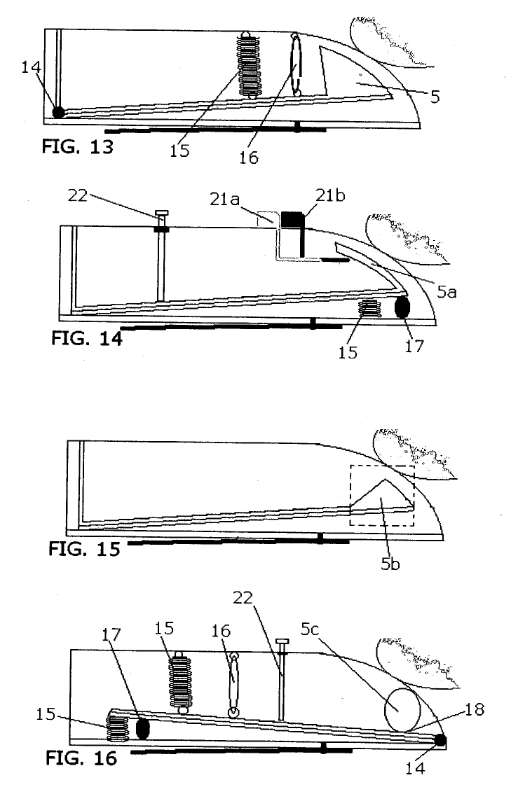

Other mechanical devices may enhance the performance of the Manual Valve Cover Plate. However, such enhancements would increase manufacturing and materials costs. FIGS. 13 through 16 show such enhancements.

FIG. 13 shows three possible enhancements. Index 14 is a hinge point. Instead of the spring arms of indices 4a and 4b of FIGS. 7 and 8 respectively, the “spring arm” would become rigid and static. A hinge at index 14 provides a means of manual valve displacement toward or away from the reed plate. The rebound now removed from the static spring arm is imparted to a spring (index 15), an elastic band (index 16), or a combination thereof.

Parts of FIG. 14 continue the alternative sources of rebound. Index 15 of FIG. 14 shows an alternative position for the spring of FIG. 13. Index 17 shows placement of a compressible rubber (plastic, cork, or elastomer) stopper for the same purpose, in combination or alone.

FIG. 14 further shows two enhancements that can enable the player to adjust the clearance between the manual valve and the reed plate. Indices 21a and 21b show a mechanism that can lock the manual valve in the open position. In 21a, the manual valve is operational, allowing an airtight seal to be formed between the manual valve and the reed plate at the player's discretion. In 21b, the manual valve is locked open. In the locked-open position, the manual valve is disabled, and the player is limited to standard techniques.

Index 22 of FIG. 14 shows an adjustment screw. The adjustment screw passes through a threaded, reinforced section of the cover plate. By turning the screw, the player can change the maximum clearance between the manual valve and the reed plate. The adjustment screw may be tipped with felt, cork, or rubber to silence the collision between screw and valve.

FIG. 15 shows location of other possible embodiments of pressure bar. Inside of the dashed rectangle of index 5b, the pressure bar may take on many embodiments. The pressure bar may have uniform or non-uniform cross section. The cross section may be any concave or convex polygon, or closed curve. The pressure bar may or may not have discrete vertices. The pressure bar may further be attached to the manual valve as shown in index 5b of FIG. 5, or it may be free-floating as shown in index 5c of FIG. 16.

FIG. 16 shows cross section of and possible enhancements to a folded version of the net shown in FIG. 12. The figure also shows possible embodiments in which any one or all of the enhancements of FIGS. 13 through 16 are added to the FIG. 12 embodiment.

In summary, what is claimed is:

1. A diatonic harmonica cover plate that aids in the prevention of unwanted air leakage at the discretion of the player by means of a manual valve controlled by lip pressure;

2. A diatonic harmonica cover plate that aids in the prevention of discordant whistling, squeaking or polyphonic vibration due to air leakage at the discretion of the player by means of a manual valve controlled by lip pressure;

3. A diatonic harmonica cover plate that exploits the advantages of flap valves without the sympathetic vibration of a flap valve (flap valve buzzing) at the discretion of the player by means of a manual valve controlled by lip pressure;

4. A diatonic harmonica cover plate with dynamic mechanical components that requires no hand or foot control;

5. A diatonic harmonica cover plate with dynamic mechanical components that can be controlled by lip pressure;

6. A diatonic harmonica cover plate that reduces the physical playing difficulty of the standard bending technique by means of a manual valve controlled by lip pressure;

7. A diatonic harmonica cover plate that reduces the physical playing difficulty of the valved bending technique by means of a manual valve controlled by lip pressure;

8. A diatonic harmonica cover plate that reduces the physical playing difficulty of the over bending technique by means of a manual valve controlled by lip pressure;

9. A diatonic harmonica cover plate that can improve overall intonation by the prevention of unwanted air leakage at the discretion of the player by means of a manual valve controlled by lip pressure;

10. A diatonic harmonica cover plate that reduces the physical playing difficulty of standard bending, valved bending, over bending, or proper intonation by means of a manual valve controlled by lip pressure while the diatonic harmonica is played in a hands-free rack;

11. A diatonic harmonica cover plate that allows for expressive control of air leakage around the reeds by means of a manual valve controlled by lip pressure.

12. A diatonic harmonica cover plate that includes a lip-operated valve that may be engaged or disengaged at the will of the player and independent of oral cavity pressure;

13. A diatonic harmonica cover plate that allows for the engaging or disengaging of a valve by lip pressure through a flexible membrane imbedded in the cover plate;

14. A diatonic harmonica cover plate that has been altered such that a window or space in the solid material has been cut, stamped, or molded in order to facilitate manual operation of a valve or switch;

15. A diatonic harmonica cover plate with a manual valve constructed of one or more pieces of metal, plastic, wood, hard rubber, or elastomer;

16. A diatonic harmonica cover plate with a mechanism that can lock the manual valve in a fixed position;

17. A diatonic harmonica cover plate with one or more screws that can be used to adjust maximum or minimum clearance of the manual valve with respect to the reed plate; and

18. A diatonic harmonica cover plate and manual valve construct in which the manual valve rebound is aided by elastic band, leaf spring, coil spring, or compressible rubber stopper.
